(19) United States
(12) Patent Application Publication
(10) Pub. No.: US 2021/0069058 A1
(43) Pub. Date: Mar. 11, 2021

(54) MASSAGE ROLLER WITH TENSION STRAP AND METHODS FOR THE SAME

(71) Applicant: Freddy Castro, Santa Maria, CA (US)

(72) Inventor: Freddy Castro, Santa Maria, CA (US)

(21) Appl. No.: 16/563,639

(22) Filed: Sep. 6, 2019

(51) Int. Cl. A61H 15/00

(52) U.S. Cl. CPC A61H 15/0092; A61H 2015/0021; A61H 2015/005; A61H 2205/04; A61H 2201/0153; A61H 2205/081; A61H 2201/0157

(57) ABSTRACT

The present invention provides an improved massage device which allows a user to apply increased pressure to his or her body via the massage device without assistance from a wall, floor, a second person, or the like, and methods of using the same. The massage device may comprise a massaging roller, an axle, a tension strap, and an axial handle. The tension strap may have first and second ends with connectors attached to the axle on opposite sides of the massaging roller, and the tension strap may be operable to wrap around to an opposite side of the user's body, allowing the user to apply tension to the strap by pushing or pulling thereon, thus increasing the pressure of the massaging roller against the user's body.

### FIELD OF THE INVENTION

The present invention relates to massage devices. More particularly, embodiments of the present invention pertain to massage rollers having a tension strap for providing pressure against the body.

### DISCUSSION OF THE BACKGROUND

Massage rollers are becoming ever more popular as useful tools for relieving tension and pain in one's muscles and other tissues by applying pressure thereto. Massage roller therapy is a form of self-myofascial release in which contracted muscles are relaxed, blood and lymphatic circulation is aided, and natural endorphins are released. Massage rollers are particularly useful after a soft tissue injury or a strenuous workout in order to relieve adhesions in the muscle or other soft tissue, allowing the muscle to relax and contract more uniformly, end to end.

Of late, massage rollers can be found everywhere from the gym, to the doctor's office, the living room, and even travel gear. Active consumers, especially those with a particular problem area or affected muscle group, want to be able to apply self-treatment via massage roller both on a treatment schedule and on an as-needed basis, no matter where they are. However, conventional massage roller systems are limited in that, for certain areas of the body, applying sufficient pressure to actually treat such tissue is impossible without help.

For example, sufficient pressure on the muscles of the back, shoulders, outer thighs, and hamstrings, is not possible via conventional massage roller systems without help from a second person or a supporting surface such as a wall to lean against or a floor lie on. In many instances, however, the user may not be in a position to utilize such help. The user may be alone, or there may not be a second person available who is willing, or familiar enough to ask for help from. Also, the user may find him or herself in a public or professional setting where it is either ill-mannered or unsanitary to lean against a wall or lie on the floor in order to create pressure against a massage roller. Further, even when such supporting surfaces are available, some muscles are difficult to target (e.g., putting downward pressure on a person's trapezius muscle) without aid from a second person.

It is therefore desirable to provide an improved massage roller device which allows a user to effectively and independently apply self-treatment.

### SUMMARY OF THE INVENTION

The present invention provides an improved massage device which allows a user to apply increased pressure to his or her body via the massage device independently (e.g., without assistance from a wall, floor, a second person, or the like), and methods of using the same. Embodiments of the present invention provide a massage device comprising a massaging roller, an axle, a tension strap, and an axial handle. The tension strap may have first and second ends with connectors attached to the axle on opposite sides of the massaging roller, and the tension strap may be operable to wrap around to an opposite side of the user's body (e.g., around a user's torso, a leg, an arm, the back of the neck, or the like) from the massaging roller, allowing the user to apply tension to the strap (e.g., to push against or pull on the strap from the opposite side of the massaging roller), thus increasing the pressure of the massaging roller against the user's body. The axial handle may then provide a grip for the user to adjust the position of the massaging roller (e.g., roll the massaging roller back and forth) over a desired area of the user's body (e.g., a sore, injured, or tight muscle, tendon, ligament, joint, or the like) while the massaging roller provides increased pressure due to tension from the tension strap. Thus, the present invention allows a user to independently achieve the therapeutic benefits of relaxing, stretching, and stimulating contracted muscles, and improving flow of the blood and lymphatic system in areas of the body which are difficult or impossible to reach with conventional massage roller systems.

The present invention provides a massaging device which allows a user to put greater pressure on a body part, at an angle at which it would otherwise be difficult to apply such pressure without utilizing a separate support structure or a second person (e.g., by leaning against a wall with a massage roller between the user and the wall in order to increase the pressure of the roller, and squatting to adjust the position of the roller; by laying on the floor on top of a massage roller to increase pressure, and sliding back and forth over the roller to adjust the position; or by having a second person push down on the roller to increase pressure and move it back and forth against a body part of the user to adjust its position).

For example, the massage roller may be placed against a user's right trapezius muscle with the axial handle facing forward and the tension strap wrapped around the user's torso, wherein a midpoint of the strap is adjacent to the user's left hip. The user may then use the user's left hand to push the tension strap down and diagonally away from the trapezius muscle, increasing the pressure of the massage roller to whatever extent the user desires and is strong enough to achieve (e.g., from approximately 0.1 PSI to approximately 50 PSI or more, and any pressure or range of pressures therebetween), and use the user's right hand to move the axial handle, rolling the massage roller back and forth over the trapezius muscle.

Alternatively, the massage roller may be placed against at least one of: a hamstring, with the tension strap wrapped around the front of the user's thigh; a latissimus dorsi muscle, with the tension strap wrapped around to the opposite side of the torso; the back of the user's neck (e.g., the splenius capitis or semispinalis capitis muscle) with the strap wrapped around to the front of the head; and other similar muscles, tendons, ligaments, or joints of the body which are typically difficult for a person to apply pressure to without assistance.

The present invention may comprise the following major components: a massaging roller, an axle, an axial handle, and a tension strap. The massaging roller may comprise a substantially cylindrical shape and may be mounted to the axle, wherein the axle protrudes from each side of the massaging roller along the central axis of the roller. In some embodiments, the massaging roller may be statically mounted to the axle (e.g., wherein the roller is not able to freely rotate about the axle), such that causing the axle to twist via the axial handle also twists the massaging roller. In other embodiments, the massaging roller may be mounted to the axle such that it is operable to freely rotate about the axle.

In some embodiments, the massaging roller may comprise a rigid or semi-rigid material, such that the massaging roller remains substantially cylindrical while under pressure against a body part due to tension on the tension strap (e.g., the roller does not bend or substantially deform against the user's body). In other embodiments, the massaging roller may comprise a pliable, resilient material, wherein when the massaging roller is under pressure from the tension strap the roller may form a shape complementary to a shape of the user's body which is in contact with the roller, and when tension from the tension strap is released the roller may resume a substantially cylindrical shape. In yet other embodiments, the massaging roller may comprise an outer layer of pliable material, and an inner layer comprising a rigid or semi-rigid material, thus providing an initial soft or supple pressure, and a more rigid secondary pressure upon putting greater tension on the tension strap.

In some embodiments, the massaging roller may comprise a rigid or semirigid material such as a metal, a metal alloy, a plastic (e.g., acrylic, PMMA, polycarbonate, PVC, polyethylene such as MDPE, HDPE or UHMWPE, another similar rigid or semirigid plastic, or a combination thereof), carbon fiber, graphene, a hard rubber, a wood, another similar rigid or semirigid material, and a combination thereof. In other embodiments, the massaging roller may comprise a supple and/or resilient material such as a soft rubber (e.g., polyisoprene, SBR, EPDM, butylrubber, polyurethane, neoprene, nitrile, silicone, another similar soft rubber material, and a combination thereof) a foam rubber (e.g., polyurethane foam, latex foam, neoprene foam, PE foam, cross linked PE foam, polystyrene foam, polypropylene foam, Volara, another similar foam rubber or a combination thereof), natural fibers, synthetic fibers, a woven material made from natural or synthetic fibers, another similar supple and/or resilient material, and a combination thereof. In yet other embodiments, the massaging roller may comprise a plurality of materials including a rigid or semi-rigid material as listed above, and a supple and/or resilient material as listed above.

In some embodiments, the massaging roller may comprise a substantially cylindrical body. In some embodiments, the substantially cylindrical body may comprise a length in a range from about 5 cm to about 1 meter, and any length or range of lengths therebetween. In some embodiments, the substantially cylindrical body may comprise a length in a range from about 10 cm to about 20 cm, and any length or range of lengths therebetween. In some embodiments, the massaging roller may comprise a plurality of massaging rollers aligned in series (e.g., end-to-end). In some embodiments, the massaging roller may comprise two massaging rollers, each having a length in a range from about 5 cm to about 10 cm. In some embodiments, the massaging roller may comprise three or more massaging rollers mounted to the axle.

In some embodiments, the massaging roller may comprise a plurality of massaging rollers arranged in series along an axle made from a semi-rigid and resilient material. The axle may thus be operable to bend upon experiencing the opposing forces applied by the tension strap and the user's body, in order to fit a shape of the user's body. In some embodiments, the user may place the massaging roller against the user's trapezius muscle, wrap the tension strap around the user's torso such that a midpoint of the strap is adjacent to the user's hip on the opposite side of the user's torso from the massaging roller, and push against the tension strap, applying a substantially downward force on the first and second ends of the axle and a substantially upward force against a midpoint of the massaging roller (due to contact with the user's body), causing the axle to bend into a curved shape complementary to a curved shape of the user's targeted trapezius muscle. Upon the user releasing tension from the tension strap, the axle may be operable to resume a default, substantially straight alignment. In some embodiments, the user may use the massage device to apply pressure to other parts of the user's body, causing the axle to bend into a shape complementary to the shape of the corresponding other part of the user's body upon putting tension on the tension strap, and the axle may be operable to return to a default, substantially straight shape upon releasing tension from the tension strap.

The massaging roller may comprise any thickness (e.g., the radial distance from an inner surface, adjacent to the axle, to the outer surface) sufficient to provide a desired cushion, and/or a desired outer diameter of the massaging roller, for optimizing comfort and/or therapeutic effect for the user. In some embodiments, the overall radial thickness of the massaging roller may be in a range from about 0.5 cm to about 10 cm, or any thickness or range of thicknesses therebetween. In some embodiments, the radial thickness of the massaging roller may comprise a thickness in a range from about 1 cm to about 5 cm, or any thickness or range of thicknesses therebetween.

In some embodiments, the massaging roller may comprise a substantially smooth outer surface. In other embodiments, the outer surface may comprise a groove or pattern of grooves, a substantially porous surface, or an otherwise rough surface in order to increase friction between the outer surface and the user's body or clothing. In yet other embodiments, the outer surface may comprise at least one raised member extending radially therefrom in order to provide an acute pressure point against the user's body (e.g., the raised member may be substantially smaller than the overall outer surface). In some embodiments, the at least one raised member may comprise a width in a range from about 0.1 cm to about 10 cm or more, or any width or range of widths therebetween. In some embodiments, the at least one raised member may comprise a width in a range from approximately 0.25 cm to approximately 2 cm, or any width or range of widths therebetween.

The at least one raised member may have a shape comprising at least one of a protuberance, a ridge, a ring, or the like, or a combination thereof. In some embodiments, the at least one raised member may comprise the same material as the remainder of the outer surface of the massaging roller. In other embodiments, the at least one raised member may comprise a different material (e.g., a more supple material or a more rigid material) than the remainder of the outer surface of the massaging roller. In some embodiments, the at least one raised member may comprise a plurality of raised members. In some embodiments, different raised members of the plurality of raised members may comprise different materials and/or shapes from each other. In some embodiments, the plurality of raised members may be arranged on the outer surface of the massage roller in any pattern useful for massaging a user's body (e.g., rows, random placement, a helical pattern, and the like, or a combination thereof).

In some embodiments, the massaging roller may comprise one or more expansions for providing a consistent raised pressure point against the user's body. The one or more expansions may each comprise an area or section of the massaging roller which has a substantially increased radius from a central axis as compared to the remainder of the outer surface of the massaging roller. In other embodiments, the expansion may comprise the entirety of the outer surface of the massaging roller. The one or more expansions may each comprise at least one of a substantially spherical shape, a substantially cylindrical shape, a shape having a substantially trapezoidal cross-section such as a square, a hexagon, an octagon, and the like. In some embodiments, an expansion may comprise the same material as another portion of the outer surface of the massaging roller. In other embodiments, an expansion may comprise a different material (e.g., a more supple material or a more rigid material) than another portion of the outer surface of the massaging roller. In some embodiments, the massaging roller may comprise a plurality of massaging rollers mounted to a resilient axle, each roller comprising at least one expansion (e.g., three massaging rollers, each having a substantially spherical overall shape).

The axle may comprise a bar or shaft operable to provide resistance to a bending force applied thereto, such a forces from the tension strap at each end of the axle (such force being substantially perpendicular to a central axis of the axle) in applied in combination with a resistant force from the user's body (e.g., an opposing force at a midpoint of the axle and substantially parallel to and opposite of the forces applied by the tension strap).

In some embodiments, the axle may comprise a rigid material. In other embodiments, the axle may comprise a semi-rigid and resilient material operable to flex in response to a bending force, and return to a straight (e.g., unbent) shape when at rest. In some embodiments, the axle may comprise a metal, a metal alloy, a plastic (e.g., acrylic, PMMA, polycarbonate, PVC, polyethylene such as MDPE, HDPE or UHMWPE, another similar rigid or semirigid plastic, or a combination thereof), carbon fiber, graphene, a wood, another similar rigid or semirigid material, and a combination thereof. In some embodiments, the axle may comprise a solid bar. In other embodiments, the axle may comprise a hollow cylinder. In yet other embodiments, the axle may comprise a plurality of layers (e.g., a plurality of thin, hollow cylindrical bodies with increasing radii, or a relatively long sheet of thin material rolled up about a central axis), with or without an adhesive material between each layer. In some embodiments, the plurality of layers may be press-fitted together. In some embodiments, the plurality of layers may comprise a first layer made from a first material and a second layer made form a second material.

The axle may comprise a first end and a second end. In some embodiments, the first end and second end may each extend out past an end of the massaging roller. In some embodiments, the axial handle may be attached to the first end and the second end may comprise a stop for preventing the tension strap from sliding off of the second end. The stop may comprise a greater outer diameter than the outer diameter of the remainder of the second end, such that a connector of the tension strap connected to the second end may be operable to rotate about the central axis of the axle and slide longitudinally along a portion of the second end, between an end of the massaging roller and the stop, but the connector is prevented from sliding off of the second end by the stop. The stop may comprise at least one of a substantially spherical shape (e.g., a knob), a disc shape (e.g., akin to the head of a nail) and a trapezoidal cross-sectional shape such as that of a hexagonal nut.

In some embodiments, the stop may be permanently attached to and integral with the second end of the axle. In some embodiments, the stop may be permanently attached to the second end via at least one of an adhesive, a weld, soldering, a press fit, frictional welding, and the like. In other embodiments, the stop may be formed on the second end via injection molding or blacksmithing, or the second end and the stop may be cut from a larger solid piece (e.g., cut from a metal billet via a lathe). In other embodiments, the stop may be removably attached to the second end. In some embodiments, the axle may comprise a threaded male end and the stop may comprise a threaded hole (e.g., similar to a nut threaded onto a bolt). In some embodiments, the stop may comprise a plurality of members (e.g., two nuts, or two nuts with a washer between them).

The axial handle may comprise a substantially cylindrical body adapted to be moved or adjusted manually. The axial handle may comprise any material operable to provide grip between (e.g., create friction between) the axial handle and a user's hand. In some embodiments, the outer surface of the axial handle may comprise at least one of a substantially tacky material, a stippled material, a supple and resilient material operable to form to a user's hand, a wavy shape complementary to a shape of a user's finger(s), another similar material and/or shape for increasing friction between the axial handle and the user's hand, and a combination thereof.

In some embodiments, the axial handle may comprise a rigid or semi-rigid material. In other embodiments, the axial handle may comprise a pliable, resilient material, wherein the outer surface of the axial handle may form a shape complementary to a shape of the user's hand when gripped by the user and return to a default shape (e.g., substantially cylindrical) when not gripped by the user. In yet other embodiments, the axial handle may comprise an outer layer of pliable material, and an inner layer comprising a rigid or semi-rigid material, thus providing an outer layer which conforms to the shape of a user's hand and an inner layer providing a rigid cylindrical base transferring a force from the user's hand to the axle.

In some embodiments, the axial handle may comprise a rigid or semirigid material such as a metal, a metal alloy, a plastic (e.g., acrylic, PMMA, polycarbonate, PVC, polyethylene such as MDPE, HDPE or UHMWPE, another similar rigid or semirigid plastic, or a combination thereof), carbon fiber, graphene, a hard rubber, a wood, another similar rigid or semirigid material, and a combination thereof. In other embodiments, the axial handle may comprise a supple and/or resilient material such as a soft rubber (e.g., polyisoprene, SBR, EPDM, butylrubber, polyurethane, neoprene, nitrile, silicone, another similar soft rubber material, and a combination thereof) a foam rubber (e.g., polyurethane foam, latex foam, neoprene foam, PE foam, cross linked PE foam, polystyrene foam, polypropylene foam, Volara, another similar foam rubber or a combination thereof), a woven material made from natural or synthetic fibers, another similar supple and/or resilient material, and a combination thereof. In yet other embodiments, the axial handle may comprise a plurality of materials including a rigid or semi-rigid material as listed above, and a supple and/or resilient material as listed above.

In some embodiments, the axial handle may be statically attached to the first end of the axle, such that twisting the axial handle also twists the axle. In other embodiments, the axial handle may be rotatably mounted to the first end, such that the user may move the axial handle back and forth (substantially perpendicularly to the axis of the axle) without twisting in order to cause the massaging roller to roll across the user's body. In some embodiments, the axial handle may be permanently attached to and integral with the first end of the axle. In some embodiments, the axial handle may be permanently attached to the first end via at least one of an adhesive, a weld, soldering, a press fit, frictional welding, and the like. In other embodiments, at least a portion of the axial handle (e.g., a rigid base) may be formed on the first end via injection molding or blacksmithing, or the first end and at least a portion of the axial handle may be cut from a larger single piece (e.g., cut from a metal billet via a lathe). In other embodiments, the axial handle may be removably attached to the first end. In some embodiments, the axle may comprise a threaded male end and axial handle may comprise a threaded hole having a shape complementary to the threaded male end.

The tension strap may be operable to wrap around a user's body or a portion thereof, and may have a first end and a second end operable to attach to the first and second ends of the axle, respectively. In some embodiments, the first end of the tension strap may comprise a first connector operable to attach to the first end of the axle between the axial handle and the massaging roller, and the second end of the tension strap may comprise a second connector operable to attach to the second end of the axle between the massaging roller and the stop.

In some embodiments, the first connector and second connector may each be operable to removably attach to the axle and may comprise at least one of a broken loop operable to clip onto the axle (e.g., similar to a carabiner or S-carabiner), a hook and loop material (e.g., Velcro) allowing the strap to wrap around the axle before being secured to itself, or the like. In other embodiments, each connector may comprise a first part permanently connected to the strap and a second part permanently connected to the axle, the first part and second part being operable to removably attach to each other (e.g., a buckle or side release buckle). In yet other embodiments, the first end and second end of the tension strap may each be permanently connected to the first end and second end of the axle, respectively. In another embodiment, one of the first end or the second end may be removably attachable to the axle, while the other end is permanently attached to the axle (e.g., the first end of the tension strap is removably attached to the axle and the second end is permanently attached to the axle). In some embodiments, the first and second connectors may each be operable to freely twist at a midpoint thereof (via, e.g., a ball and socket connector) allowing the ends of the tension strap to freely twist in relation to the axle.

The tension strap may comprise any material suitable to provide tension to the first and second ends of the axle, causing increased pressure between the massaging roller and the user's body. In some embodiments, the tension strap may comprise at least one of a web material, a woven material, a cord, a band, a bent rod, or the like. In some embodiments, the tension strap may be flexible and elastic (e.g., a bungee cord). In other embodiments, the tension strap may be flexible but substantially inelastic (e.g., a polyester web or a leather band). In yet other embodiments, the tension strap may comprise a rigid shape complementary to a portion of the user's body (e.g., a metal rod bent to a shape operable to wrap around the user's upper leg, or around the user's neck or head).

The tension strap may comprise any length suitable for wrapping around a portion of the user's body and allowing the user to push or pull on the tension strap in order to increase the pressure provided by the massaging roller. An appropriate length of the tension strap may depend upon the body part to be massaged and/or one or more dimensions of the user's body (e.g., a longer tension strap for a user having long limbs and/or a thick torso, or massaging the user's trapezius muscle, and a shorter tension strap for users having short limbs, a thin torso, or massaging the user's neck or hamstring). In some embodiments, the tension strap may comprise a length in a range from approximately one foot to approximately ten feet, or any length therebetween. In some embodiments, the tension strap may comprise a length adjuster for increasing or decreasing the effective length of the tension strap. In some embodiments, the length adjuster may comprise a ladder lock buckle, a cam buckle, a tri-glide buckle, or other similar length adjusting device, or a combination thereof.

In some embodiments, the tension strap may comprise a tension handle. The tension handle may comprise any device operable to provide improved grip or comfort to a user's hand while pushing against or pulling on the tension strap. In some embodiments, the tension handle may comprise a pad with an attachment device (e.g., a hook and loop material such as Velcro, a snap, a button, a zipper, a tie, and the like) for securing the pad to the tension strap. In some embodiments, the pad may be operable to wrap around and be slidably secured to the tension strap (e.g., comparable to the shoulder pads used on straps for luggage, gym bags, laptop bags, etc.). In other embodiments, the tension handle may comprise a portion of the strap (e.g., a portion ranging from approximately 3 inches to approximately 6 inches in length, and any length or range of lengths therebetween) which has been folded over on itself (e.g., the tension strap folded length-wise) with the edges secured together via sewing, an adhesive, a hook and loop material such as Velcro, a snap, a button, or the like, or a combination thereof.

A method of using the present invention may comprise the steps of: 1) providing a massage device having a massaging roller mounted to an axle, and a tension strap operable to be connected to the axle, the axle comprising a first end having an axial handle and a second end having a stop, and the tension strap being operable to connect to the axle at the first end and at the second end; 2) putting the massaging roller in contact with a body part of a user; 3) wrapping the tension strap around the user's body or a portion thereof; and 4) applying tension to the tension strap. In some embodiments, the method may further include the step of adjusting a position of the massaging roller via the handle. In some embodiments, the step of applying tension to the tension strap may comprise pushing or pulling on the tension strap manually (e.g., the user may push or pull on the strap by hand, or with another body part such as an elbow, a foot, a knee, or the like). In some embodiments, the handle and the massaging roller may each be statically mounted to the axle, and the step of adjusting a position of the massaging roller via the handle may comprise twisting the handle. In other embodiments, the massaging roller may be rotatably mounted to the axle and the step of adjusting a position of the massaging roller may comprise moving the handle back and forth without the need to twist the handle (e.g., along a plane substantially perpendicular to a central axis of the axle and substantially parallel to a surface of the user's body. In another embodiment, the step of adjusting a position of the massaging roller may comprise moving the axial handle in a plane perpendicular to a surface of the user's body (e.g., moving the handle up and down so that the massaging roller rotates about a midpoint of the axle). In some embodiments, the method may further comprise the step of connecting at least one end of the tension strap to an end of the axle. In some embodiments, the method may further comprise the step of adjusting a length of the tension strap.

The present invention provides an improved massage device operable to allow a single user to quickly and easily apply increased pressure against a part of the user's body via a massaging roller without the aid of a separate supporting surface or a second person. These and other features and objects of the invention will be apparent from the description provided herein.

It is an object of the present invention to provide a massage device which allows a user to massage a part of the user's body without the aid of a separate support surface.

It is an object of the present invention to provide a massage device which allows a user to apply increased pressure to a part of the user's body via the massaging device, without the aid of a second person.

It is an object of the present invention to provide a massage device which allows a single user increase the pressure of the massage device against the user's body by pushing against or pulling on a tension strap.

It is an object of the present invention to provide a massage device which allows a single user to apply increased pressure to a part of the user's body with one hand, via a tension strap, and to adjust a position of a massaging roller against the user's body with the other hand.

It is an object of the present invention to provide a massage device having a tension strap which is easy to wrap around a user's body and to adjust in length, such that the user may comfortably apply tension to the tension strap by pushing against or pulling on the tension strap by hand.

The above-described objects, advantages and features of the invention, together with the organization and manner of operation thereof, will become apparent from the following detailed description when taken in conjunction with the accompanying drawings, wherein like elements have like numerals throughout the several drawings described herein. Further benefits and other advantages of the present invention will become readily apparent from the detailed description of the preferred embodiments.

### BRIEF DESCRIPTION OF THE DRAWINGS

FIGS. 1A and 1B each provide a side view of a massage device, according to an embodiment of the present invention.

FIG. 2A provides a front view of a method of using a massage device, according to an embodiment of the present invention.

FIG. 2B provides a rear view of a method of using a massage device, according to an embodiment of the present invention.

FIGS. 3A and 3B each provide a perspective view of a massage device, according to an embodiment of the present invention.

FIGS. 4A and 4B each provide a side view of a massage device, according to an embodiment of the present invention.

### DETAILED DESCRIPTION

Reference will now be made in detail to certain embodiments of the invention, examples of which are illustrated in the accompanying drawings. While the invention will be described in reference to these embodiments, it will be understood that they are not intended to limit the invention. To the contrary, the invention is intended to cover alternatives, modifications, and equivalents that are included within the spirit and scope of the invention as defined by the claims. In the following disclosure, specific details are given to provide a thorough understanding of the invention. However, it will be apparent to one skilled in the art that the present invention may be practiced without these specific details.

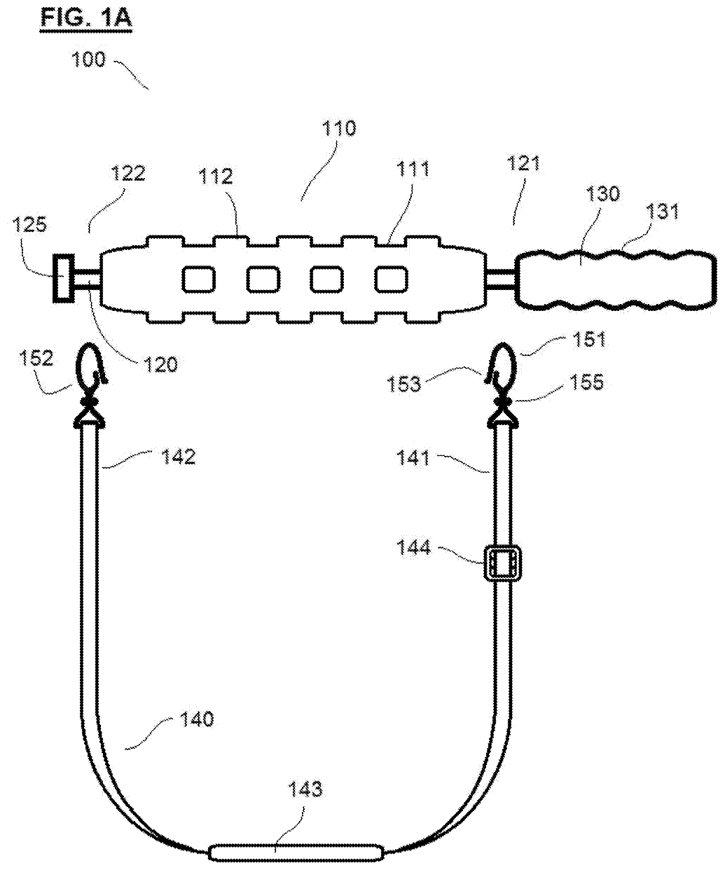

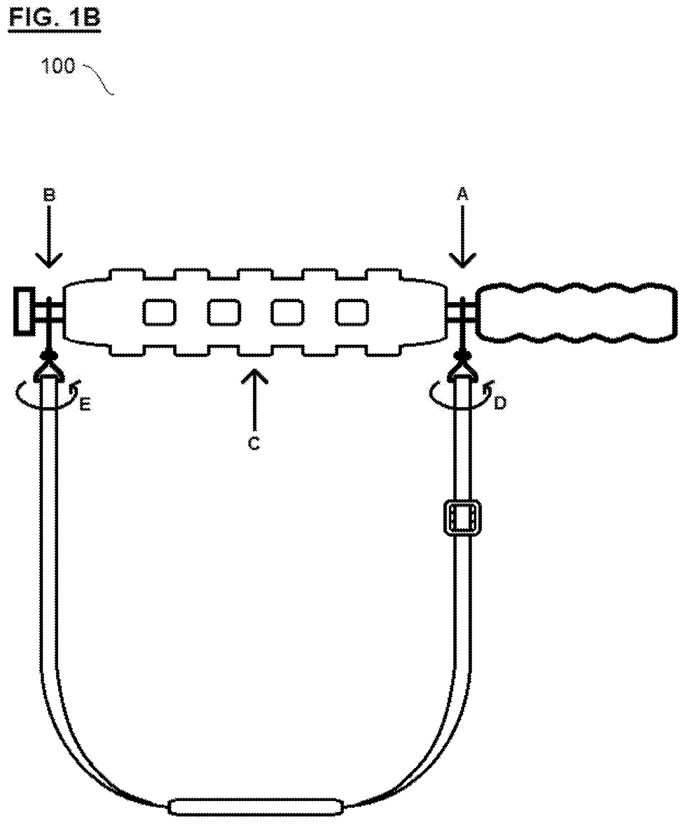

Referring to the drawings wherein like reference characters designate like or corresponding parts throughout the several views, and referring to FIGS. 1-4, it is seen that the present invention includes various embodiments of an improved massage device including a tension strap, allowing a user to increase the pressure of a massage roller without the need for a wall, floor, or second person. An exemplary device may include a massaging roller, an axle, an axial handle, and a tension strap.

As seen in FIGS. 1A and 1B, the present invention provides a system and method for using a massage device 100, the massage device 100 comprising a massaging roller 110, an axle 120, an axial handle 130, and a tension strap 140. The massaging roller 110 may comprise a substantially cylindrical shape and may be mounted to the axle 120, wherein the axle 120 protrudes from each side of the massaging roller 110 along a central axis of the massaging roller 110. The massaging roller 110 may be statically mounted to the axle 120 such that it is not able to freely rotate about the axle 120 and causing the axle 120 to rotate by manually twisting the axial handle 130 also rotates the massaging roller 110.

The massaging roller 110 may comprise a pliable, resilient material, wherein an outer surface 111 of the massaging roller 110 may form a shape complementary to a shape of a user's body underneath the massaging roller 110 when the massaging roller 110 is under pressure due to tension from the tension strap 140, and resume a substantially cylindrical shape when not under pressure from the tension strap 140. The outer surface 111 may comprise a plurality of raised members 112 extending radially therefrom in order to provide an acute pressure point against the user's body. The plurality of raised members 112 may each comprise a substantially square protuberance shape, and may comprise the same material as the remainder of the outer surface 111 of the massaging roller 110. The plurality of raised members 112 may be arranged on the outer surface 111 in any pattern useful for massaging a user's body, such as in rows.

The axle 120 may comprise a solid bar made from a rigid material (e.g., a metal) operable to resist bending when directional forces A, B (see FIG. 1B) from the tension strap 140 at each end of the axle 120 are applied in combination with a resistant force C from contact with the user's body. The axle 120 may comprise a first end 121 and a second end 122, each of the first end 121 and second end 122 extending out past an end of the massaging roller 110. The axial handle 130 may be attached to the first end 121 and the second end 122 may comprise a stop 125 for preventing a second connector 152 the tension strap 140 from sliding off of the second end 122. The stop 125 may comprise a disc shape having a greater outer diameter than the outer diameter of the remainder of the second end 122, such that the second connector 152 may be free to rotate about a central axis of the axle 120 and slide longitudinally along a portion of the second end 120, between the massaging roller 110 and the stop 125, but the second connector 152 is prevented from sliding off of the second end 122 by the stop 125. The stop 125 may be permanently attached to and integral with the second end 122 of the axle 120.

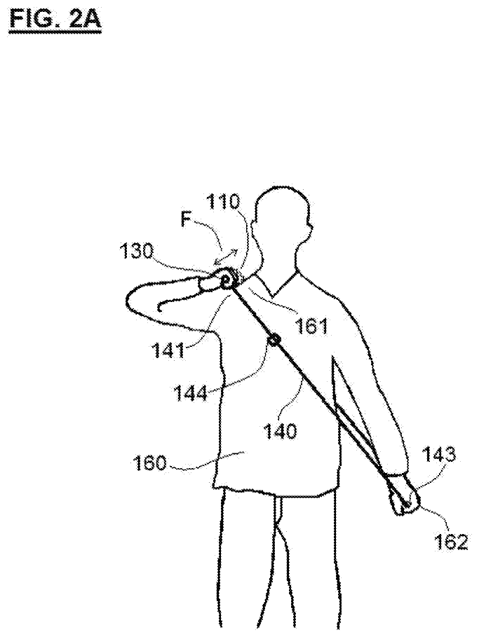

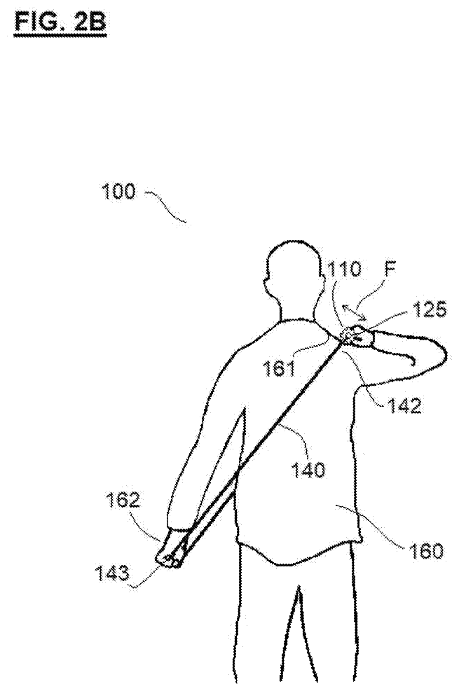

The axial handle 130 may comprise a substantially cylindrical body having a grip 131 on an outer surface thereof, the axial handle being adapted to be moved or adjusted manually. The outer surface of the axial handle 130 may comprise a semi-rigid material operable to provide friction between the outer surface and a user's hand, and the grip 131 may comprise a shape complementary to a shape of the user's hand (e.g., a wavy shape complementary to a shape of a user's fingers). The axial handle 130 may be permanently and statically attached to the first end 121 of the axle 120, such that twisting the axial handle back and forth 130 rotates the axle 120, thereby rotating the massaging roller 110 back and forth (see F; FIGS. 2A and 2B) over a targeted part 161 of the user's body 160.

The tension strap 140 may be operable to wrap around a user's body 160 (see FIGS. 2A and 2B) or a portion thereof, and may have a first end 141 comprising a first connector 151 and a second end 142 comprising a second connector 152 operable to attach to the first end 121 and second end 122 of the axle 120, respectively. The first connector 151 may be operable to attach to the first end 121 of the axle 120 between the axial handle 130 and the massaging roller 110, and the second connector 122 may be operable to attach to the second end 122 end of the axle 120 between the massaging roller 110 and the stop 125. The first connector 151 and second connector 152 may each comprise a clip 153, allowing the first connector 151 and second connector 152 to be removably attached to the axle 120, and a twistable member 155 (e.g., a ball joint) allowing the first end 141 of the tension strap 140 to twist freely (see D) while attached to the first end 121 of the axle 120, and the second end 142 of the tension strap 140 to twist freely (see E) while attached to the second end 122 of the axle 120.

The tension strap 140 may comprise a length suitable for wrapping around the user's body 160 or a portion thereof and allowing the user to comfortably push against a handle 143 of the tension strap 140 (see FIGS. 2A and 2B) in order to increase a pressure of the massaging roller 110 on a targeted part 161 (e.g., a trapezius muscle) of the user's body 160. The tension handle 143 may be operable to provide improved grip or comfort to a user's hand 162 while pushing against or pulling on the tension strap 140. The tension handle 143 may comprise a pad slidably secured to the tension strap 140 such that the position of the pad along a length of the tension strap 140 may be adjusted. The tension strap may further comprise a length adjuster 144 (e.g., a ladder lock buckle) for adjusting a length of the tension strap 140 to fit different users and different parts of a user's body 160.

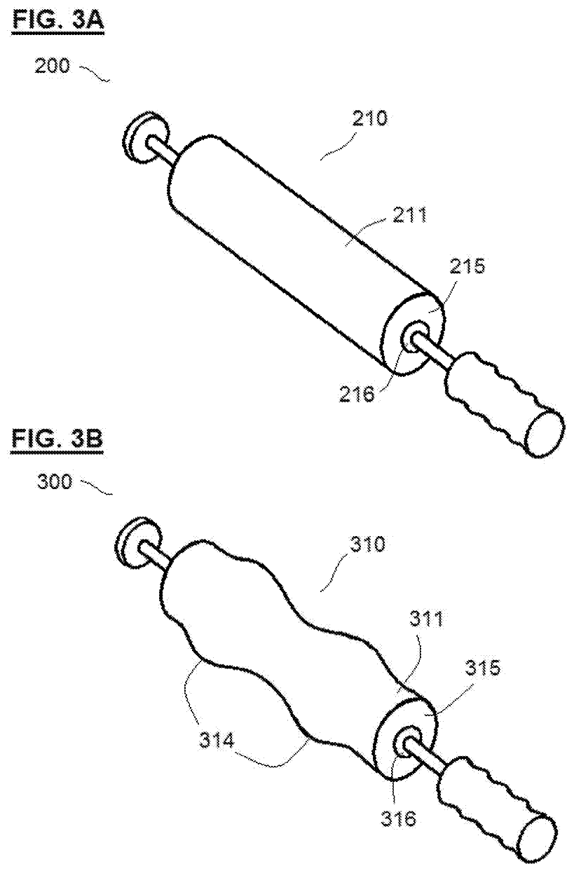

As seen in FIG. 3A, in an alternative embodiment of the massage device 200, the outer surface 211 of the massaging roller 210 may comprise a substantially cylindrical shape, without any raised members. The massage device 200 also comprises a tension strap 140, which is omitted in FIG. 3A for the purpose of clarity. The massaging roller 210 may comprise an outer layer 215 of pliable and resilient material, and an inner layer 216 comprising a rigid or semi-rigid material. The massaging roller 210 may thus provide an initial soft or supple contact against the targeted part 161 of the user's body (e.g., due to compression of the outer layer 215) when the pressure between massaging roller 210 and the targeted part 161 of the user's body is low (e.g., in a range from initial contact—e.g., 0 PSI—up to about to about 1 PSI, or up to about 2 PSI, or up to about 5 PSI, or up to about 10 PSI or any pressure or range of pressures therebetween), and a more rigid contact against the targeted part 161 of the user's body (e.g., due to pressure from the inner layer 216 after the outer layer 215 has been substantially fully compressed) when the pressure between the massaging roller 210 and the targeted part 161 of the user's body is high (e.g., equal to or greater than about 1 PSI, or about 2 PSI, or about 5 PSI, or about 10 PSI, or any pressure or range of pressures therebetween).

FIG. 3B shows another alternative embodiment of the massage device 300 wherein the outer layer 315—and thus the outer surface 311—of the massaging roller 210 comprises a plurality of expansions 314, the plurality of expansions 314 each providing a raised pressure point against the targeted part 161 of the user's body 160. The plurality of expansions may each comprise an area or section of the massaging roller 210 which has a substantially increased diameter as compared to the remainder of the outer surface 311 of the massaging roller 310. The massage device 300 again comprises a tension strap 140, which has been omitted from FIG. 3B for the purpose of clarity.

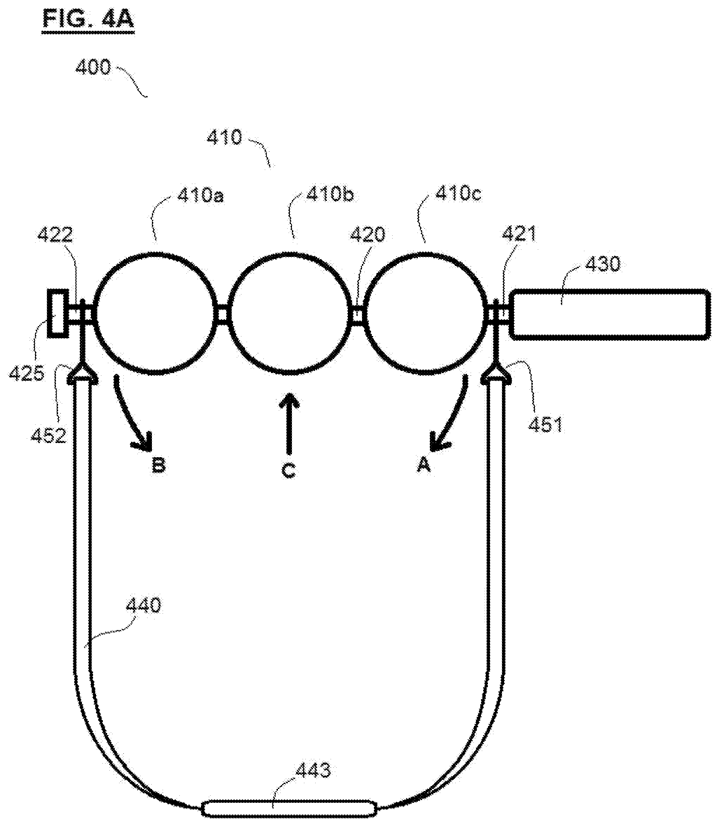

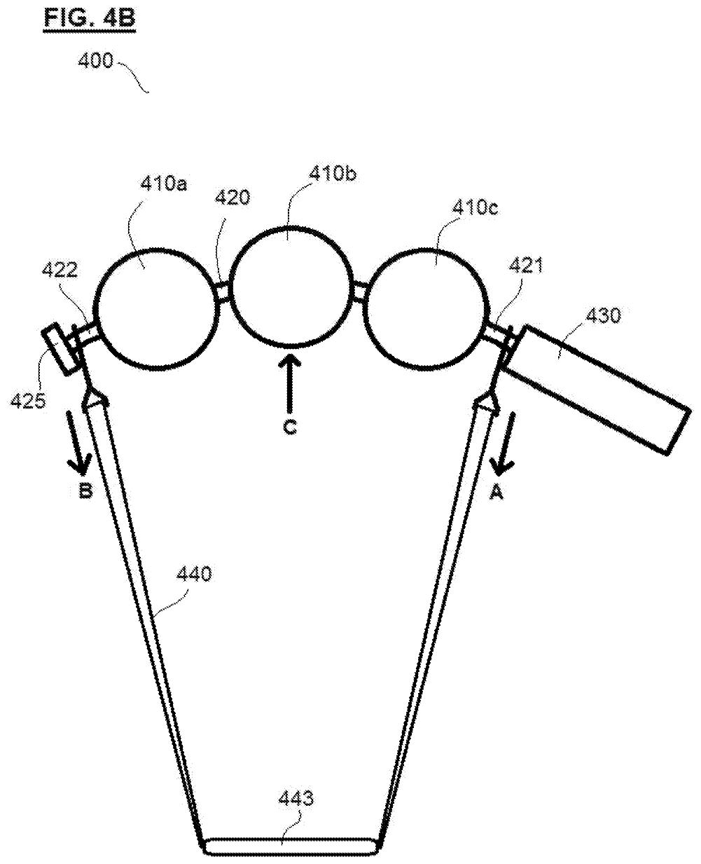

FIG. 4A shows a massage device 400 according to an embodiment of the present invention. The massaging roller 410 may comprise a plurality of massaging rollers 410a, 410b, 410c aligned in series along an axle 420 made from a semi-rigid and resilient material. The axle 420 may thus be operable to bend (see FIG. 4B) upon experiencing the forces A, B applied by the tension strap 440 and force C applied by the user's body, in order to fit a shape of the user's body. For example, the user may place the massaging roller 410 against the user's trapezius muscle, wrap the tension strap 440 around the user's torso such that a midpoint of the strap is adjacent to the user's hip on the opposite side of the user's torso from the massaging roller 410, and push against the tension strap 440 via the tension handle 442, applying substantially downward forces A, B on the first 421 and second 422 ends of the axle 420, and a substantially upward force C against a midpoint (e.g., the lower surface of 410b) of the massaging roller 410 due to contact with the user's body, causing the axle 420 to bend into a curved shape complementary to a curved shape of the user's targeted trapezius muscle. Upon the user releasing tension from the tension strap 440, the resilient axle 420 may be operable to resume a default, substantially straight alignment (as depicted in FIG. 4A).

It should be understood that the foregoing descriptions of specific embodiments of the present invention have been presented for purposes of illustration and description. They are not intended to be exhaustive or to limit the invention to the precise forms disclosed, and obviously many modifications and variations are possible in light of the above teachings. The embodiments were chosen and described in order to best explain the principles of the invention and its practical application, and to thereby enable others skilled in the art to best utilize the invention and various embodiments with various modifications as are suited to the particular use contemplated.

What is claimed:

1. A massage device comprising a massaging roller, an axle, a tension strap, and an axial handle.

2. The massage device of claim 1, wherein said axle comprises a first end and a second end, and said tension strap comprises a first connector operable to connect to said first end and a second connector operable to connect to said second end.

3. The massage device of claim 2, wherein said massaging roller is mounted about said axle, said first end protruding from a first side of said massaging roller and said second end protruding from a second side of said massaging roller.

4. The massage device of claim 3, wherein said axial handle is coaxially mounted to said first end, and said second end comprises a stop for preventing said tension strap from sliding off of said second end.

5. The massage device of claim 4, wherein said massaging roller is rotatably mounted to said axle.

6. The massage device of claim 4, wherein said stop is removably mounted to said second end.

7. The massage device of claim 4, wherein said axial handle is rotatably mounted to said first end.

8. The massage device of claim 4, wherein said axial handle provides a grip for a user to adjust a position of the massaging roller against a desired area of said user's body, said massaging roller providing pressure against said desired area due to tension applied to said tension strap.

9. The massage device of claim 4, wherein said tension strap is operable to wrap around to an opposite side of a user's body from said massage roller, such that said user is able to apply tension to said tension strap by pushing or pulling on said tension strap, thereby increasing pressure of the massaging roller against a part of said user's body.

10. The massage device of claim 9, wherein said part of said user's body comprises a trapezius muscle of said user, and wherein a midpoint of said tension strap is adjacent to a hip of said user.

11. The massage device of claim 4, wherein said axle comprises a flexible and resilient material operable to bend from a default shape into a curved shape complementary to a shape of said user's body when tension is applied to said tension strap, and to resume said default shape when said tension is released.

12. The massage device of claim 1, wherein said massaging roller comprises a substantially cylindrical body.

13. The massage device of claim 1, wherein said massaging roller comprises a pattern of grooves on an outer surface thereof.

14. The massage device of claim 1, wherein said massaging roller comprises at least one raised member on an outer surface thereof.

15. The massage device of claim 1, wherein said massaging roller comprises at least one expansion.

16. The massage device of claim 1, wherein said massaging roller comprises a plurality of massaging rollers arranged in series along said axle.

17. The massage device of claim 16, wherein said plurality of massaging rollers each comprise a substantially spherical shape.

18. A method of using a massage device, comprising the steps of:
a. providing a massage device having a massaging roller mounted about an axle, and a tension strap, said axle comprising a first end having an axial handle and a second end having a stop, and said tension strap being operable to connect to said axle at said first end and at said second end;
b. putting said massaging roller in contact with a body part of a user;
c. wrapping said tension strap around a portion of said user's body; and
d. applying tension to said tension strap.

19. The method of claim 18, further comprising the step of:
a. adjusting a position of said massaging roller via said axial handle.

20. The Method of claim 18, further comprising the steps of:
a. connecting an end of said tension strap to said axle; and
b. adjusting a length of said tension strap.
